(19) United States
(12) Patent Application Publication
(10) Pub. No.: US 2024/0084768 A1
(43) Pub. Date: Mar. 14, 2024

(54) FUEL INJECTOR DEVICES, SYSTEMS, AND METHODS

(71) Applicant: Cummins Inc., Columbus, IN (US)

(72) Inventors: Vivek Vasant Parab, Pune (IN); Quereeta Ranjan, Bengaluru (IN); Panendra Kumar Sahu, Punawale Pimpri Chinchwad (IN); Purva Sainath Rasal, Ratnagiri (IN); Amol Jagannath Bobade, Pune (IN)

(21) Appl. No.: 18/514,250

(22) Filed: Nov. 20, 2023

Related U.S. Application Data
(63) Continuation of application No. PCT/US22/32169, filed on Jun. 3, 2022.

(30) Foreign Application Priority Data
Jun. 4, 2021 (IN) 202111024920

(51) Int. Cl. F02M 51/06; F02M 61/16

(52) U.S. Cl. CPC F02M 51/0667; F02M 61/168

(57) ABSTRACT

Disclosed herein is an armature for a fuel injector. The fuel injector can have a longitudinal axis extending centrally therethrough. The armature can be configured to be positioned adjacent a gap in the fuel injector and configured to move along the longitudinal axis between first and second positions. In this regard, the armature can move in a proximal direction as the armature moves from the first position to the second position. Under these circumstances, fuel is forced out of the gap. The armature can move in the distal direction as the armature moves from the second position to the first position. Under these circumstances, fuel can be drawn into the gap. The armature can include a hydraulic separation feature configured to improve hydraulic separation of the armature such that a travel time between the first and second positions are reduced as the armature comes to rest. The hydraulic separation feature can include at least one of a modified mass, a modified overtravel diameter, and one or more diffusion holes.

### FIELD OF THE DISCLOSURE

The present disclosure generally relates to fuel injectors for an engine, and more specifically, to fuel injectors that produce improved hydraulic separation capabilities.

### BACKGROUND

Internal combustion engines use high pressure in the delivery of fuel for combustion. Internal combustion engines use fuel injectors having needle valves to deliver fuel. When such needle valves are open, fuel flows therein. Accordingly, needle valves facilitate and regulate fuel flow to the internal combustion engine for engine operation.

Fuel injectors may include an armature to electromagnetically regulate fuel flow through the fuel injector. The armature typically performs sequential movements in the form of pulses along a designated path of travel. A time gap between an end of one pulse and a start of a next pulse is called hydraulic separation. Smaller hydraulic separation accommodates more pulses in a given combustion time frame and correspondingly minimizes injector multi-pulse fueling errors.

A fuel injector with a flow control valve is disclosed in U.S. Published Patent Application No. 2009/0267008. In this application, an electromagnetic valve includes an extra-high pressure injection system control valve having soft metal powder particles in a magnetic stator core. Electroless nickel plating is applied to the stator core to provide an intermediate surface to absorb grinding wheel stress as a working face is exposed during manufacturing, as well as an external compression layer or casing to hold or encapsulate the powder particles in place and together during assembly and use.

### SUMMARY

According to principles of the present disclosure, fuel injector can include a body and an armature assembly. The body can have a longitudinal axis extending between a proximal end and a distal end of the body. The armature assembly can be configured to be received within the body and including an armature and a stator that are arranged so as to form a gap therebetween. The armature can be configured to move along the longitudinal axis between first and second positions relative to the stator. In this regard, the armature can move toward the stator as the armature moves from the first position to the second position. Under these circumstances, fuel can be forced out of the gap. The armature can move away from the stator as the armature moves from the second position to the first position. Under these circumstances, fuel can be drawn into the gap. The armature can include a hydraulic separation feature configured to improve hydraulic separation of the armature such that a travel time between the first and second positions are reduced as the armature comes to rest. The hydraulic separation feature can include at least one of a modified mass, a modified overtravel diameter, and one or more diffusion holes.

In examples, the travel time between the first and second positions can include the travel time between the first position and the second position as well as the travel time over an overtravel distance.

In examples, the hydraulic separation feature can include at least one of an optimized mass, an optimized overtravel diameter, and one or more diffusion holes. In examples, the hydraulic separation feature can include an optimized mass and an optimized overtravel diameter. In examples, the hydraulic separation feature can include an optimized mass and one or more diffusion holes.

In examples, when the one or more diffusion holes can be a plurality of diffusion holes through a flange of the armature. The plurality of diffusion holes can be radially spaced about the longitudinal axis. In examples, the plurality of diffusion holes can include at least 4 diffusion holes. In examples, a diameter of each diffusion hole in the one or more diffusion holes can be from about 1 millimeter to about 2 millimeters.

In examples, the optimized mass can be from about 7 grams to about 8 grams.

In examples, the optimized overtravel diameter can be an overtravel diameter that is reduced along the length of the armature in the direction from the proximal end to the distal end. In examples, the overtravel diameter is transitioned to from a first diameter of a nominal diameter to the overtravel diameter via a chamfered transition between the upper diameter and the overtravel diameter. In examples, the overtravel diameter near the distal end of the armature can less than or equal to about 5 millimeters over a length of the armature.

Disclosed herein are methods of optimizing an armature in a fuel injector for reduced travel time. A method can include selecting the armature, which can be configured to travel between first and second positions relative to a stator included in the fuel injector. The method can include machining a hydraulic separation feature into a body of the armature. The hydraulic separation feature can be configured to improve hydraulic separation of the armature such that a travel time between the first and second positions are reduced as the armature comes to rest. The hydraulic separation feature can include at least one of a modified mass, a modified overtravel diameter, and one or more diffusion holes.

In examples of the method, the travel time between the first and second positions can include the travel time between the first position and the second position as well as the travel time over an overtravel distance. In examples of the method, the hydraulic separation feature can include at least one of an optimized mass, an optimized overtravel diameter, one or more diffusion holes.

In examples of the method, the hydraulic separation feature can include each of an optimized mass and an optimized overtravel diameter or each of the hydraulic separation feature includes an optimized mass and one or more diffusion holes.

In examples of the method, the hydraulic separation feature can include one or more diffusion holes. The one or more diffusion holes can be a plurality of diffusion holes through a flange of the armature. The plurality of diffusion holes can be radially spaced about the longitudinal axis.

In examples of the method, the optimized overtravel diameter is an overtravel diameter can be reduced along the length of the armature in the direction from the proximal end to the distal end. The overtravel diameter can be transitioned to from a first diameter of a nominal diameter to the overtravel diameter via a chamfered transition between the upper diameter and the overtravel diameter. The overtravel diameter near the distal end of the armature can be less than or equal to about 5 millimeters over a length of the armature.

Disclosed herein is an armature for a fuel injector. The fuel injector can have a longitudinal axis extending centrally therethrough. The armature can be configured to be positioned adjacent a gap in the fuel injector and configured to move along the longitudinal axis between first and second positions. In this regard, the armature can move in a proximal direction as the armature moves from the first position to the second position. Under these circumstances, fuel is forced out of the gap. The armature can move in the distal direction as the armature moves from the second position to the first position. Under these circumstances, fuel can be drawn into the gap. The armature can include a hydraulic separation feature configured to improve hydraulic separation of the armature such that a travel time between the first and second positions are reduced as the armature comes to rest. The hydraulic separation feature includes at least one of a modified mass, a modified overtravel diameter, and one or more diffusion holes.

In examples, the travel time between the first and second positions can include the travel time between the first position and the second position as well as the travel time over an overtravel distance. In examples, the hydraulic separation feature can include at least one of an optimized mass, an optimized overtravel diameter, and one or more diffusion holes.

In examples, the hydraulic separation feature can include an optimized mass and an optimized overtravel diameter, or the hydraulic separation feature can include an optimized mass and one or more diffusion holes.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1 is a cross-sectional view of a fuel injector including an armature configured according to aspects of the present disclosure;

FIG. 2 is a cross-sectional view of a flow control valve of the fuel injector in FIG. 1, with the armature shown in the second position;

FIG. 3 is a magnified view of an armature in the flow control valve of FIG. 2;

FIG. 4 is a diagrammatic plan view of an armature;

FIG. 5 is a cross-sectional view of the armature in FIG. 4 taken at a midplane through the length of the armature;

FIG. 6 is a top view of the armature in FIG. 4;

FIG. 7 is a cross-sectional view of an armature in a first configuration taken at a midplane through the length of the armature;

FIG. 8 is a top view of the armature in FIG. 7;

FIG. 9 is a flow diagram during upward travel of the armature in FIG. 7;

FIG. 10 is a flow diagram during downward travel of the armature in FIG. 7;

FIG. 11 is a cross-sectional view of an armature in a second configuration taken at a midplane through the length of the armature;

FIG. 12 is a cross-sectional view of an armature in a third configuration taken at a midplane through the length of the armature;

FIG. 13 is a cross-sectional view of an armature in a fourth configuration taken at a midplane through the length of the armature;

FIG. 14 is a cross-sectional view of an armature in a fifth configuration taken at a midplane through the length of the armature;

FIG. 15 shows a diagram plotting the fueling error versus hydraulic separation for configurations of an armature according to aspects of the present disclosure; and

FIG. 16 is a flowchart of a method of manufacturing an armature with a hydraulic separation feature.

FIG. 17 is a diagrammatic illustration of a method by which the fuel injector may be operated, in accordance with embodiments.

FIG. 18 is a diagrammatic cross sectional illustration of portions of the fuel injector, with the armature shown in the first position.

Corresponding reference characters indicate corresponding parts throughout the several views. Although the drawings represent embodiments of various features and components according to the present disclosure, the drawings are not necessarily to scale and certain features can be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

The present disclosure advantageously provides design considerations for flow control valves for fuel injectors to improve hydraulic separation capabilities of an armature in a fuel injector. Disclosed herein are improved fuel injectors that are advantageously structured to reduce the travel time of the armature in the fuel injector. Moreover, some embodiments of such fuel injectors may provide smaller hydraulic separation, which may minimize injector multi-pulse fueling errors.

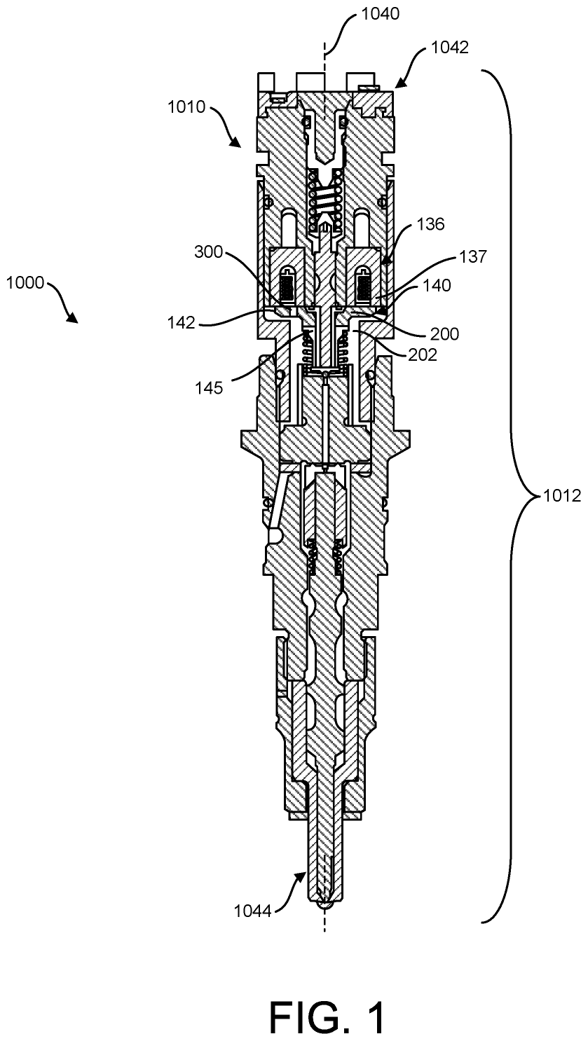

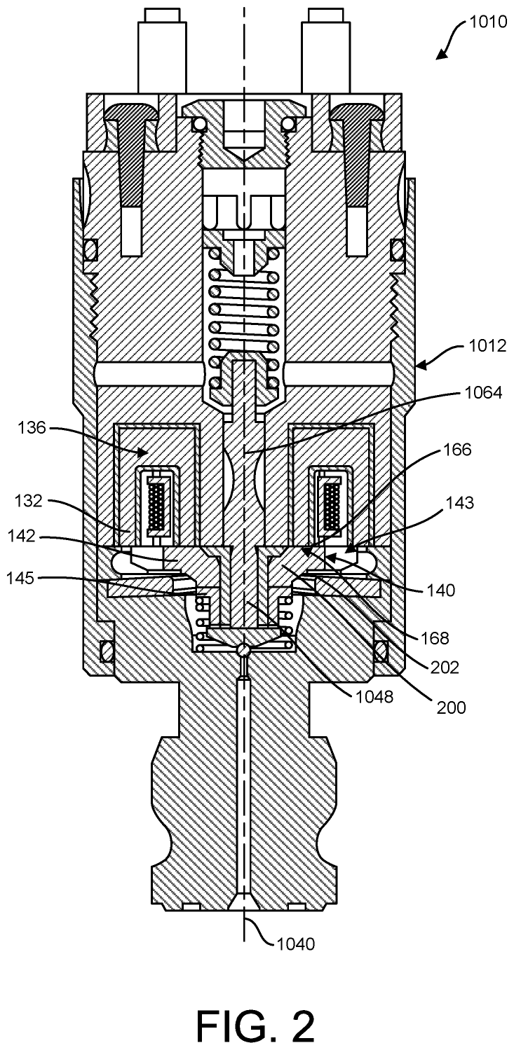

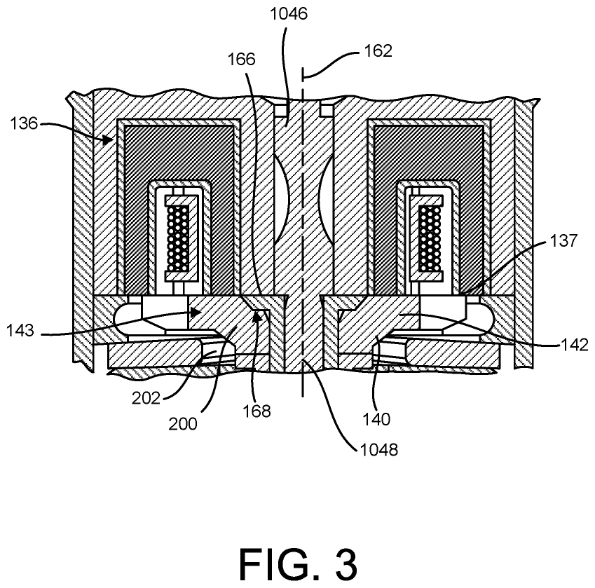

FIG. 1 is a cross sectional illustration of a fuel injector 1000 including a flow control valve 1010 and an armature 140 in accordance with embodiments. FIG. 2 is a detailed cross-sectional illustration of the flow control valve 1010 and armature 140. FIG. 3 is a magnified view of the armature 140 in the flow control valve 1010 of FIG. 2. FIGS. 2 and 3 are presented herein to show that the novel armature 140 of the present disclosure may be implemented in a particular fuel injector and flow control valve. Nonetheless, while the present disclosure describes particular configurations of control valve 1010, the features of the present disclosure can be used on any flow control valve 1010 compatible with the features of the present disclosure. For example, the flow control valve 1010 can be in the form of an Extreme Pressure Injection (XPI) flow control valve 1010.

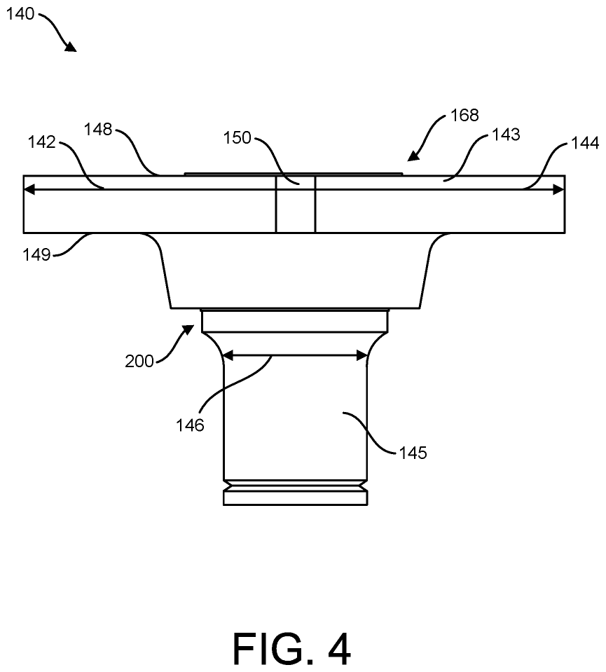

As shown in these figures, in general, the armature 140 includes an armature body 200 (see FIG. 4) that includes the flange 142, having an upper diameter portion 143 having an upper diameter 144, and an overtravel diameter portion 145 having an overtravel diameter 146. Accordingly, the armature 140 includes the flange 142, the upper diameter portion 143, and the overtravel diameter portion 145. The armature 140 defines a bore 150 through which an armature longitudinal axis 162 extends, such as the central axis shown here. The armature 140 shown here is integrally manufactured such that the body 200 is a single piece. Of course, it is not outside the scope of this disclosure to manufacture the armature 140 from discrete components.

As shown in FIGS. 1 and/or 2 the fuel injector 1000 can include a body 1012, a stator assembly 136 that includes a stator 137, and an armature 140. The body 1012 can have a longitudinal axis 1040 extending between a proximal end 1042 and a distal end 1044 of the body 1012. The body 1012 includes a rod member 1046. The longitudinal axis 1040 extends along the rod member 1046. The rod member 1046 includes a portion 1048 that extends into the armature 140. When the armature 140 is assembled into the fuel injector 1000, the armature longitudinal axis 162 co-axially aligns with the longitudinal axis 1040. Further, the fuel injector 1000 includes a stator assembly 136. When the armature 140 is assembled into the fuel injector 1000, a gap 166 can be defined between the stator assembly 136 and the armature 140.

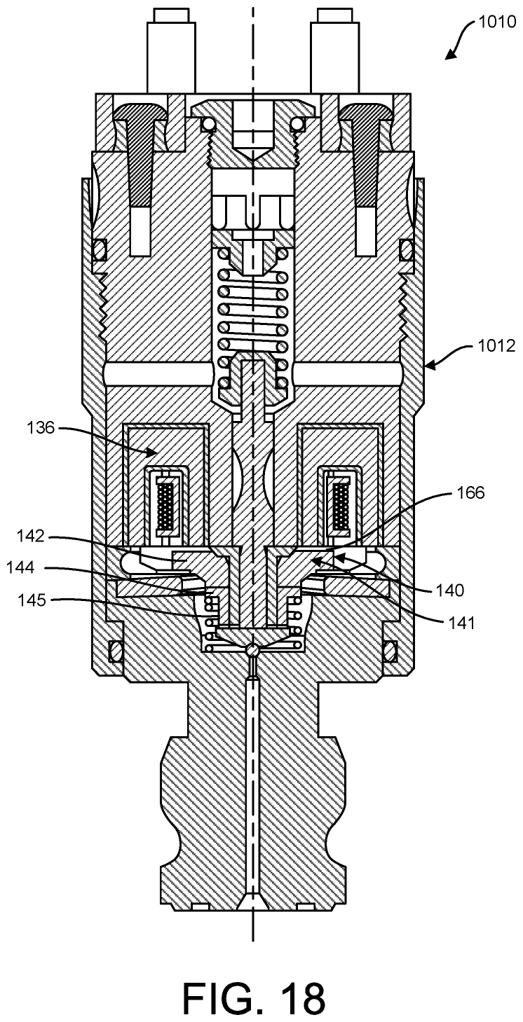

The armature 140 can be configured to be received within the body 1012 and arranged relative to the stator assembly 136 so as to form the gap 166 therebetween. The armature 140 can be configured to move along the longitudinal axis 162 between first and second positions relative to the stator assembly 136 and stator 137. The first position 141 of the armature 140, as shown for example in FIG. 18, is spaced apart from the stator assembly 136 and stator 137, and the second position 143 of the armature 140 is near the stator assembly 136 and stator 137, closer to the stator assembly 136 than the first position, as shown in FIGS. 1-3. The gap 166 is larger when the armature 140 is at the first position and is smaller or closed when the armature 140 is at the second position.

In this regard, the armature 140 can move toward the stator 137 as the armature 140 moves from the first position to the second position. Under these circumstances, fuel can be forced out of the gap 166. The armature 140 can move away from the stator 137 as the armature 140 moves from the second position to the first position. Under these circumstances, fuel can be drawn into the gap 166. The armature 140 includes a hydraulic separation feature in accordance with one or more embodiments described herein and configured to improve hydraulic separation of the armature 140 such that a travel time between the first and second positions can be reduced as compared to previous embodiments as the armature 140 comes to rest. In examples, the travel time between the first and second positions can include the travel time between the first position and the second position as well as the travel time over an overtravel distance.

For example, the armature body 200 is configured to enable the movement of the armature 140 as described herein. More specifically, the armature 140 reciprocally moves within a bore 202 of the fuel injector 1000. The flange 142 is configured to force fluid, such as fuel, through the gap 166 as the armature 140 moves from the first position toward the second position. As the armature 140 moves from the second position toward the first position, the flange 142 is configured to draw the fluid into the gap 166.

The hydraulic separation feature is defined in or along the body 200 of the armature 140. The hydraulic separation feature interacts with a fluid flow, such as a fuel flow, around the armature 140. For example, as the armature 140 travels between the first and second positions, the hydraulic separation feature alleviates pressure in the fluid by, for example, allowing some fluid flow through the body 200 and/or creating less pressure in the fluid as compared to armatures without hydraulic separation features.

FIGS. 1-3 diagrammatically show an armature 140 configuration that can be modified according to principles and any one or more embodiments of the present disclosure. As discussed further below, modifications to a baseline configuration of an armature (e.g., embodiments not including the hydraulic separation features described herein) can include any or more of configurations employing a hydraulic separation feature or combinations thereof. In examples, the hydraulic separation feature of the present disclosure can include at least one of one or more diffusion holes (e.g., diffusion holes 300), a modified mass structure 310, and a modified overtravel diameter structure 320. In examples, the hydraulic separation feature can include a modified mass structure 310 and a modified overtravel diameter structure 320. In examples, the hydraulic separation feature can include a modified mass structure 310 and one or more diffusion holes 300. Each of these hydraulic separation features can be employed without detrimentally affecting operation, specifically interaction between the stator assembly 136 and the armature 140 of the fuel injector. While some specific dimensions are used, it should be understood that more general scaling concepts can be employed without departing from the scope of this disclosure.

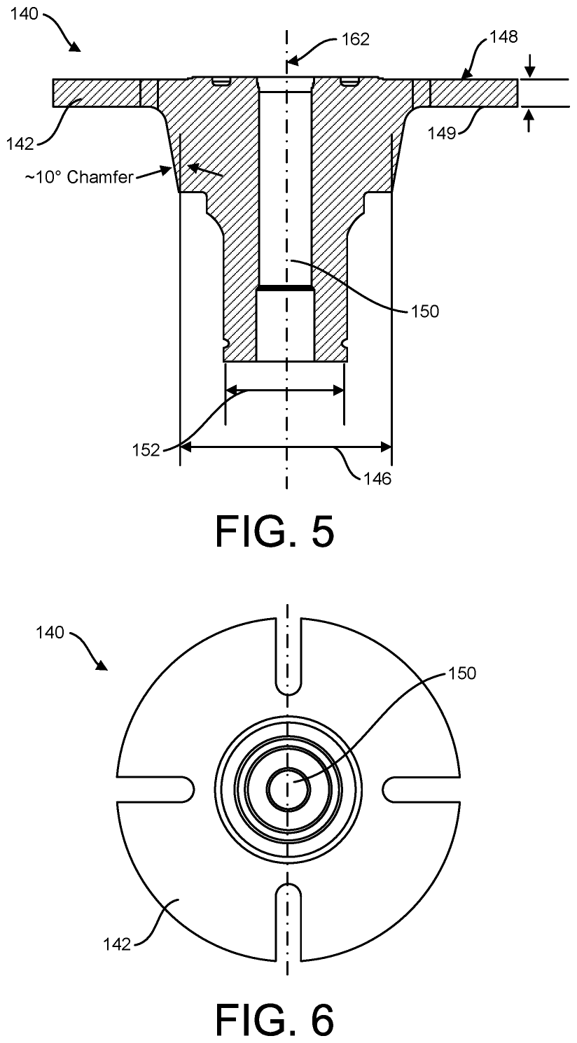

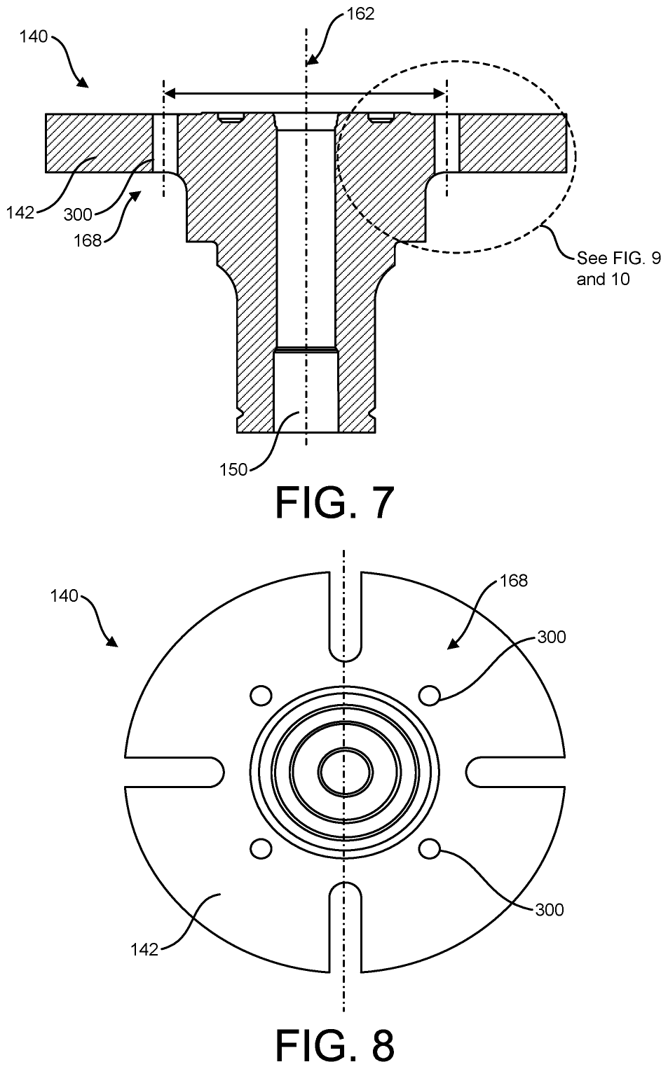

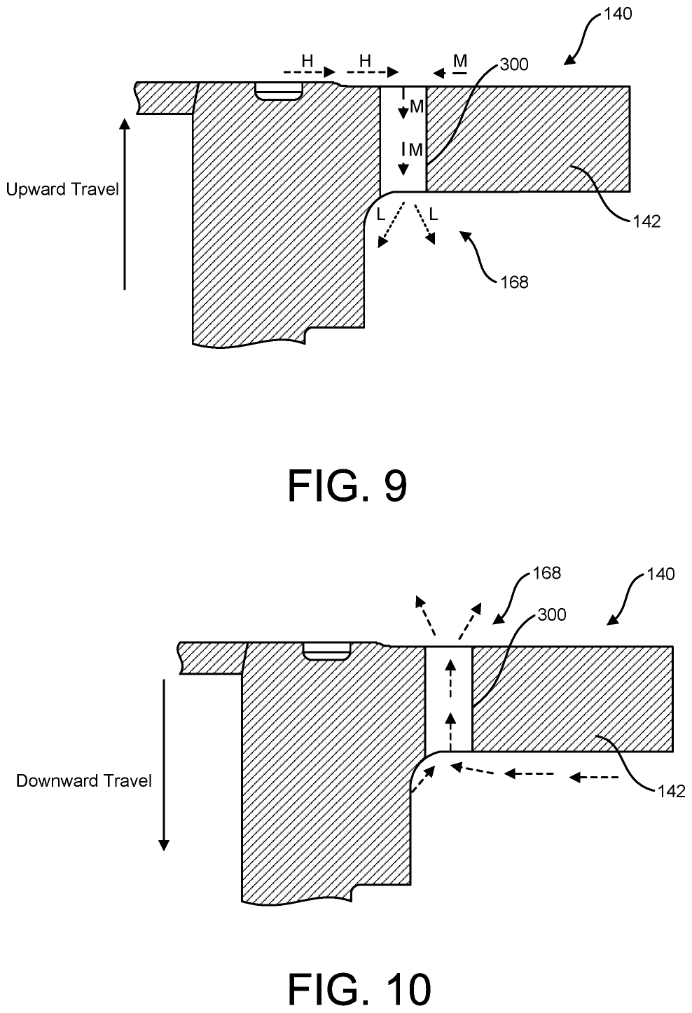

In this regard, FIG. 4 is a plan view of the armature 140. FIG. 5 is a cross-sectional view of the armature 140 in FIG. 4 taken at a midplane through the length of the armature 140. FIG. 6 is a top view of the armature 140 in FIG. 4. FIGS. 7-10 show various features of a first configuration of the armature 140. In the first configuration, the armature 140 can include one or more diffusion holes 300, and specifically a plurality of diffusion holes 300 in some examples, as the hydraulic separation feature (shown in FIGS. 1-3). FIG. 7 is a cross-sectional view of an armature 140 in the first configuration taken at a midplane through the length of the armature 140. FIG. 8 is a top view of the armature 140 in the first configuration. FIGS. 9 and 10 are diagrammatic views of fluid flow through the diffusion holes 300 during upward and downward travel of the armature 140 respectively during operation. For illustrative purposes, fluid flow in FIG. 9 is indicated by the dashed arrows having a corresponding “H” where there are high-pressure spikes, “M” where there are moderate-pressure spikes, and “L” where there are low-pressure spikes. The first configuration provides diffusion of pressure and, hence, increase of velocity in upward, downward, and overtravel stroke travel. This helps armature 140 to cover the total distance (e.g., of upward, downward, and overtravel stroke travel) in a shorter amount of time before coming to rest.

In examples, the one or more diffusion holes 300 can be a plurality of diffusion holes 300 defined through the flange 142 of the armature 140. The plurality of diffusion holes 300 can be radially spaced about the longitudinal axis 162. In examples, the plurality of diffusion holes 300 can include at least 4 (e.g., 5, 7, 8, 11, and the like) diffusion holes 300. Any number of diffusion holes, their cross section (variable or constant), their arrangement (e.g., symmetrical, asymmetrical, staggered, etc.) are considered within the scope of this disclosure though not discussed herein at length. The specific examples herein are intended to be illustrative of this principle.

An example armature 140 in the first configuration will now be discussed in detail. The diffusion holes 300 can be parallel to the center or longitudinal axis 162 of armature 140. In the illustrated example, there are 4 diffusion holes 300 of approximately 1.1 mm diameter, symmetrically distributed, at a radially fixed distance from the center axis of armature 140. In this regard, the diffusion holes 300 are spaced about 5.65 mm from the center axis. Range of diffusion hole sizes can vary from about 0.85 to 1.3 mm in accordance with some aspects. Center-to-center spacing of the diffusion holes 300 can range from about 10.5 to 12.5 mm in accordance with some aspects.

The diffusion holes 300 can influence fluid flow during all points of travel of the armature 140. During upward travel of the armature 140, fluid on an upper surface 148 of the flange 142 compresses and can lead to high pressure spikes. Presence of diffusion holes 300 helps in diffusing squeeze film pressure spikes during armature travel and hence can increase a velocity of the armature 140. During downward travel of the armature 140, fluid, such as fuel, flows from a lower surface 149 of the flange 142 to the upper surface 148 of the flange 142 via the diffusion holes 300 and thereby can reduce hydraulic drag on the armature 140 and increase the downward velocity. This helps the armature 140 to enter with a comparative higher velocity than known armatures into overtravel. During overtravel, the armature 140 moves downward and then upward as the armature 140 comes to rest. Fluid flowing via the diffusion holes 300 helps in further reducing the hydraulic drag on flange 142 during overtravel and helps the armature 140 to cover the overtravel distance in a shorter amount of time before coming to rest.

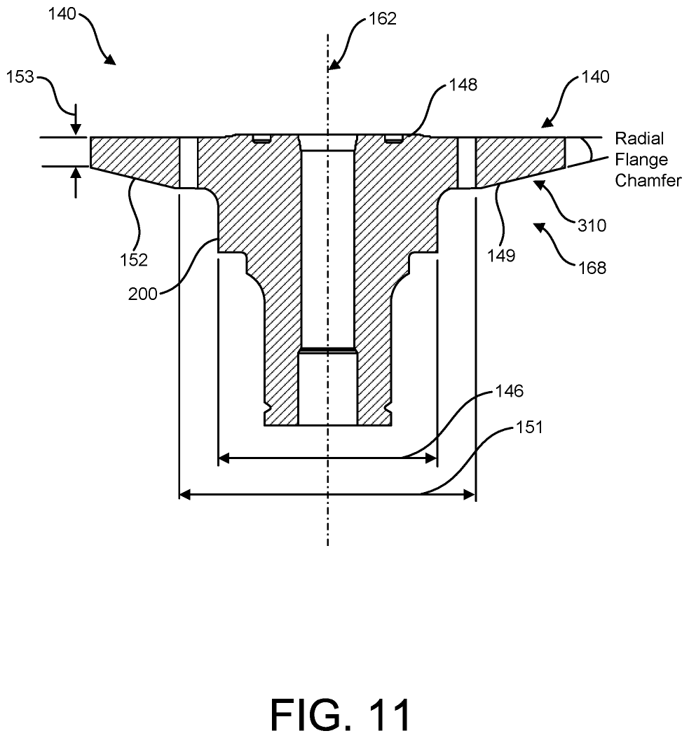

FIG. 11 shows various features of a second configuration of the armature 140. In the second configuration, the armature 140 can include a mass optimization feature such as modified mass structure 310 as the hydraulic separation feature. By reducing the mass and hence the momentum, as compared to previous embodiments, for example, the armature 140 can travel a shorter distance in overtravel stroke and can come to rest in a shorter amount of time than at least some known armatures. In examples, mass of the armature 140 is reduced by about 10% from that of a baseline armature. For example, a baseline armature may have a mass of about 8.5 g, and the armature 140 with mass optimization can range in mass from about 7 to 8 g (e.g., about 7.5 g). Reduction in armature 140 mass by about 10% helps in reducing armature 140 momentum while entering the overtravel motion and can allow the armature 140 to travel less distance in overtravel stroke.

For instance, with mass optimization there can be less spring compression and faster acceleration with the lower mass. This can result in the armature 140 coming to rest in a shorter duration of time. In examples, mass can be removed from the lower surface 149 of the flange 142 (e.g., forming a chamfer 150 in the direction radially outward from the center axis to the periphery of the flange 142) beyond the diameter portion 151. For instance, the flange 142 can have a thickness 153 of between 1.2 and 1.5 mm (e.g., 1.34 mm, 1.42 mm) and include a chamfer of about 10 to 15 degrees (e.g., 12, 13, 15 degrees) radially inward from the periphery of the flange 142. In other examples, the flange 142 can include a chamfer of about 20 to 30 degrees (e.g., 21, 24, 26 degrees) radially inward from the periphery of the flange 142. In addition, the upper diameter 144 can be reduced beyond the diameter portion 151 by about 1% (e.g., from 9.6 mm diameter to a 9.5 mm diameter) while having minimal impact on magnetic forces required to operate the armature 140. In this regard, a chamfer at the periphery of the upper diameter can be removed.

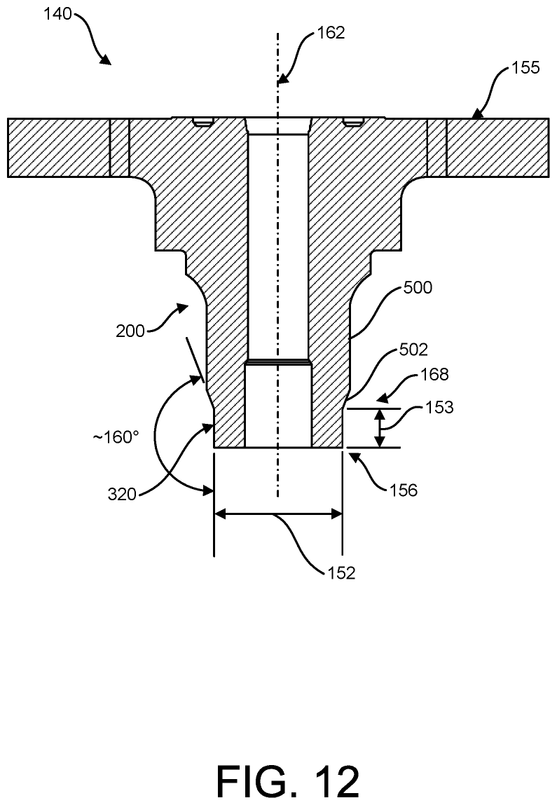

FIG. 12 shows various features of a third configuration of the armature 140. In the third configuration, the armature 140 can include a modified overtravel diameter structure 320 as the hydraulic separation feature. By reducing the overtravel diameter 152 of the overtravel diameter structure 320, e.g., as compared to a baseline configuration, the armature 140 can encounter less resistance during overtravel stroke. In examples, the modified overtravel diameter structure 320 can have an overtravel diameter 152 that is reduced along the length 153 of the armature 140 in the direction from the proximal end 155 to the distal end 156. This helps the armature 140 to cover the overtravel distance in a shorter amount of time before coming to rest. In examples, the overtravel diameter 152 (e.g., the face in contact with the squeeze film) can be reduced by about 25%.

In examples, the overtravel diameter 152 is near the distal end 156 of the armature 140 and can be less than or equal to about 5 millimeters over a length 153 of the armature 140. In examples, the length 153 is about 1.5 mm. For instance, overtravel diameter 152 can be reduced from about 5.55 mm to be about 4.95 mm through a step chamfer design. In examples, the overtravel diameter 152 is transitioned to from a first diameter of a nominal diameter of a portion 500 of the body 200 to the overtravel diameter 152 via a chamfered transition 502 between the nominal diameter at the portion 500 and the overtravel diameter 152. The first diameter can be greater than the second diameter (e.g., by a multiple of about 2). In examples, the first diameter is about 9.5 mm and the second diameter is about 4 mm. Chamfered transition 502 can help in controlling part-to-part variation through tighter control of upper diameter 146 or overtravel diameter 152 in manufacturing. A range of percentage reduction can vary from about 15 to 55%. By reducing the length of the overtravel diameter 152 in this way, a corresponding face or face surface area (which can be in contact with the squeeze film), the armature 140 faces lesser squeeze film resistance during overtravel motion. This helps to cover the overtravel distance in a shorter amount of time before coming to rest. It should also be noted that reducing the overtravel diameter 152 also reduces the face or face surface area of the lower surface (at a distal end) of the armature 140. In examples, the chamfered section 502 can be about 160 degrees, and the resulting face or face surface is between 1 and 2 mm.

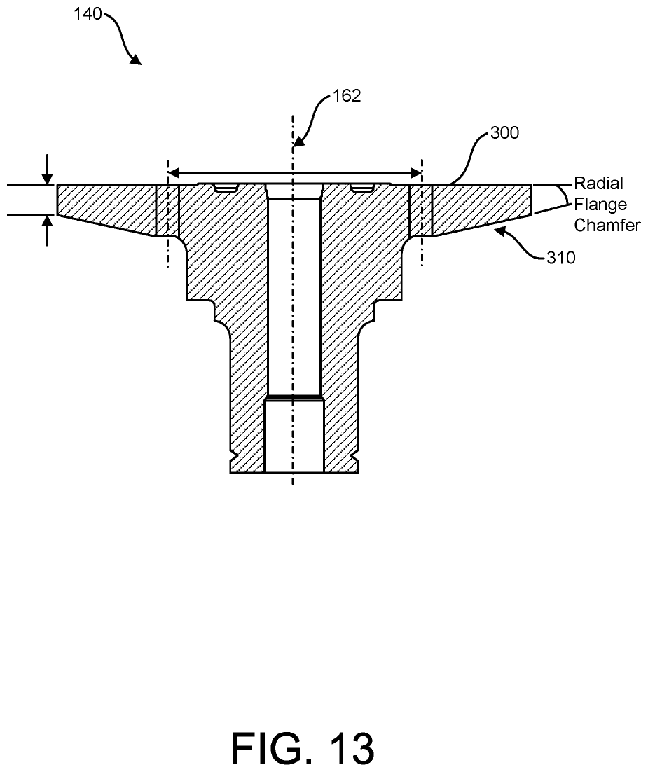

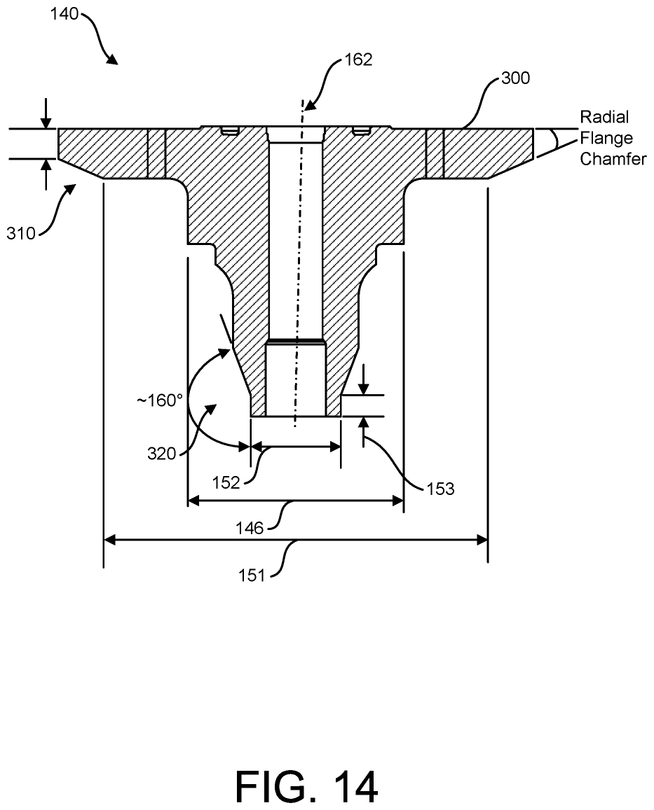

As noted above, certain design features can be combined. FIGS. 13 and 14 show some examples of this concept. In particular, FIG. 13 shows an armature 140 in a fourth configuration that combines the first and second configurations of the hydraulic separation features (e.g., diffusion holes 300 and modified mass structure 310), and FIG. 14 shows an armature 140 in a fifth configuration that combines the second and third configurations of the hydraulic separation features (e.g., modified mass structure 310 and modified overtravel diameter structure 320). While only these combinations are illustrated, one skilled in the art can appreciate that other combinations (e.g., of the first and third configurations and the first, second, and third configurations) exist. Of course, the fourth and fifth configurations can be useful in certain implementations. It has been demonstrated, however, that the illustrated combinations provide useful advantages over other combinations.

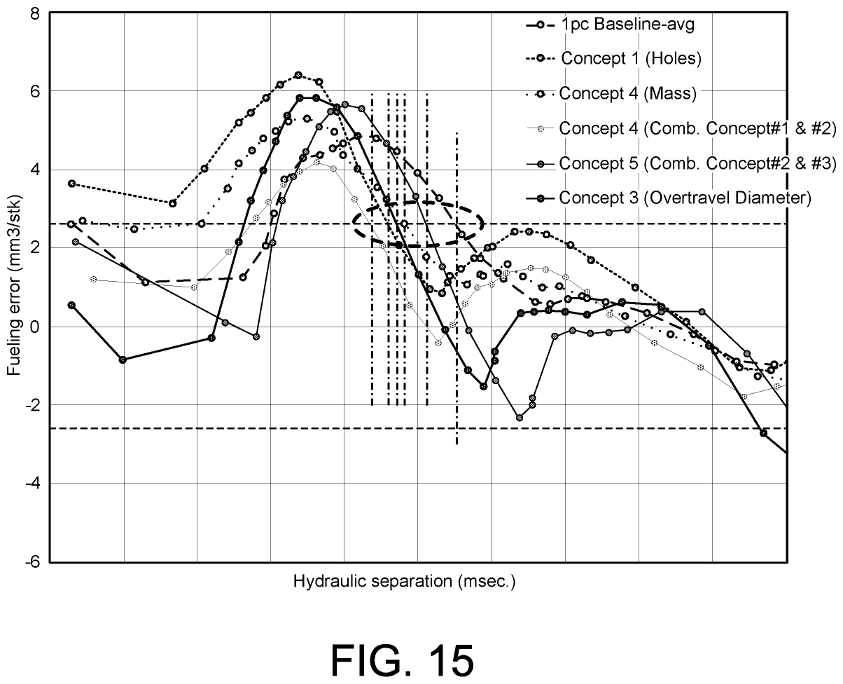

FIG. 15 shows a diagram plotting the fueling error versus hydraulic separation. In this example, a fueling error band (e.g., between +/− about 2.3 mm³/stk as indicated by the dashed horizontal lines that are parallel with the 0 axis) was set as a performance criterion. This is intended for conceptual purposes and should not limit this disclosure in any way. One skilled in the art will appreciate that other bands and values can be selected based on the desired implementation. In FIG. 15, injector multi-pulse fueling error with respect to hydraulic separation change is plotted for all five configurations and compared with a baseline configuration. Smaller hydraulic separation (e.g., inside the black circle where the curve crosses back into the band of +/− about 2.3 mm³/stk) results in better injector multi-pulse performance. It can be seen that, in this example, the fourth configuration has shown best performance, followed by the first, third, and second configurations respectively.

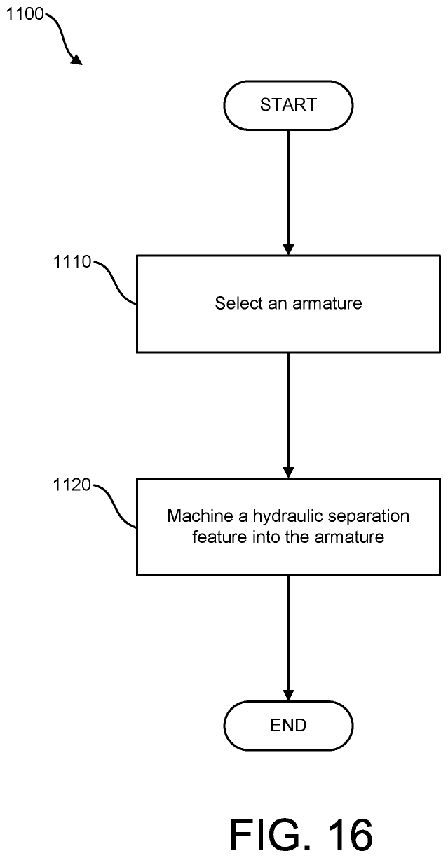

Disclosed herein are methods of optimizing an armature 140 in a fuel injector 1000 for reduced travel time. These methods can include any of the functions and features as it pertains to the devices and systems discussed elsewhere herein. FIG. 16 is a flowchart of a method 1100 of manufacturing an armature with a hydraulic separation feature. Of course, similar methods disclosed herein can be used to modify armatures to include a hydraulic separation feature.

As shown in FIG. 16, the method 1100 can include selecting the armature, which can be configured to travel between first and second positions relative to a stator included in the fuel injector, at step 1110. The armature can be similar to those discussed elsewhere herein. At step 1120, the method can include machining a hydraulic separation feature into a body of the armature. The hydraulic separation feature can be configured to improve hydraulic separation of the armature such that a travel time between the first and second positions are reduced as the armature comes to rest.

In examples of the method, the travel time between the first and second positions can include the travel time between the first position and the second position as well as the travel time over an overtravel distance. In examples of the method, the hydraulic separation feature can include at least one of a modified mass structure, a modified overtravel diameter structure, and/or one or more diffusion holes. In examples of the method, the hydraulic separation feature can include each of a modified mass structure and a modified overtravel diameter structure or each of a modified mass structure and one or more diffusion holes. In examples of the method, the hydraulic separation feature can include one or more diffusion holes. The one or more diffusion holes can be a plurality of diffusion holes through a flange of the armature. The plurality of diffusion holes can be radially spaced about the longitudinal axis.

Machining the hydraulic separation feature into a body of the armature may take a variety of forms. For instance, this machining can be performed such that the travel time between the first and second positions includes the travel time between the first position and the second position as well as the travel time over an overtravel distance. Machining the hydraulic separation feature into a body of the armature includes either machining the body of the armature to have the modified mass structure and the modified overtravel diameter structure or machining the body of the armature to have the modified mass structure and the one or more diffusion holes. Machining the hydraulic separation feature into a body of the armature includes machining the body of the armature to have the one or more diffusion holes. Optionally, the one or more diffusion holes is a plurality of diffusion holes through a flange of the armature. Optionally, the diffusion holes are radially spaced about a longitudinal axis of the fuel injector. Machining the hydraulic separation feature into a body of the armature may be done to include the modified overtravel diameter structure. Optionally, the overtravel diameter structure is reduced along a length of the armature in a direction from a proximal end of the armature to a distal end of the armature such that the overtravel diameter is transitioned to from a first diameter of a nominal diameter to the overtravel diameter via a chamfered transition between the nominal diameter and the overtravel diameter and the overtravel diameter is less than or equal to about 5 millimeters over the length of the armature.

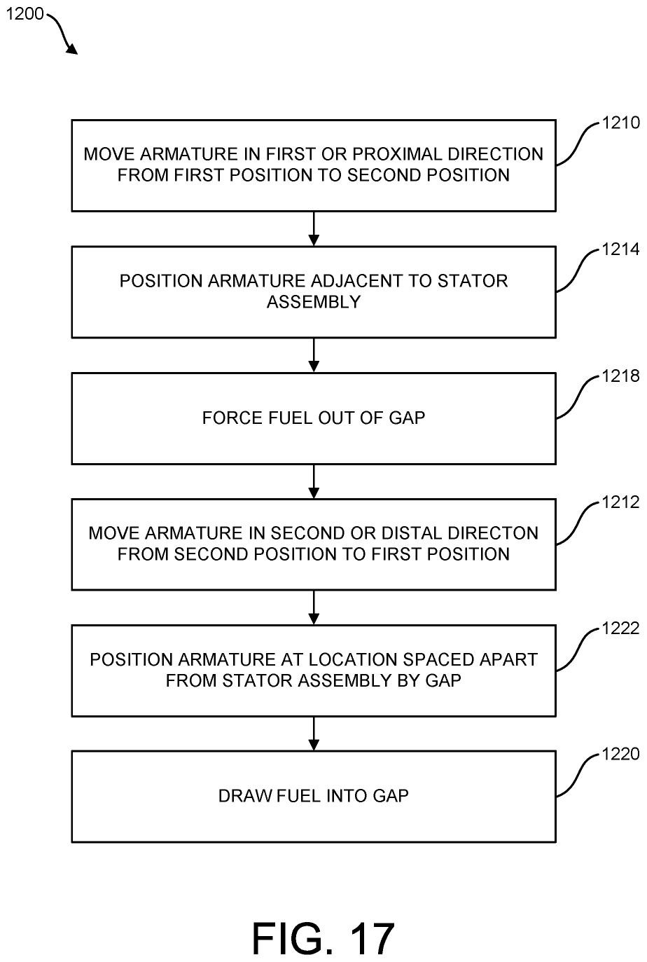

FIG. 17 is a diagrammatic illustration of a method 1200 by which fuel injectors such as 1000 including an armature 140 with one or more hydraulic separation features may be operated. As shown at step 1210, the armature 140 is moved in a first or proximal direction between a first position defining a gap 166 between the armature and the stator assembly 136 and a second position. As shown at step 1214, by this step 1210 operation, the armature 140 may be positioned adjacent to the stator assembly 136. By these steps 1210 and 1214, fuel is forced out of the gap 166, for example by the flange 142, as shown by step 1218. Step 1210 includes moving a bore 150 of the armature along an axis 1042 of the fuel injector 1000 in examples.

As shown at step 1212, the armature 140 is moved in a second or distal direction between the second position and the first position. The armature 140 is positioned at a location spaced apart from the stator assembly 136 by the gap 166 by this step 1212, as shown by step 1222. By these steps 1212 and 1222, fuel is drawn into the gap 166 as shown by step 1220. Pressures on the fuel injector components, such as the armature 140 and the stator assembly 136, may be reduced by the hydraulic separation features during the operation of method 1200.

As used herein, the modifier “about” used in connection with a quantity is inclusive of the stated value and has the meaning dictated by the context (for example, it includes at least the degree of error associated with the measurement of the particular quantity). When used in context of a range, the modifier “about” should also be considered as disclosing the range defined by the absolute values of the two endpoints. For example, the range “from about 2 to about 4” also disclosed the range “from 2 to 4.”

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art can utilize their teachings. It is not beyond the scope of this disclosure to have a number (e.g., more than one or all) the features in a given embodiment to be used across all embodiments.

Throughout this disclosure, the words “distal,” “lower,” and words of similar effect will correspond to portions of the fuel injector that are downstream relative to other portions in terms of the flow of fuel from the injector to the combustion chamber of an engine, such as the injector openings or spray holes. Similarly, the words “proximal,” “upper,” and words of similar effect will correspond to portions of the fuel injector that are upstream of the downstream portions.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus

While the present disclosure has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. An armature for a fuel injector with a longitudinal axis, the armature being configured to be positioned adjacent a gap in the fuel injector and configured to move along the longitudinal axis between first and second positions such that the armature moves in a proximal direction as the armature moves from the first position to the second position so as to force fuel out of the gap and moves in a distal direction as the armature moves from the second position to the first position so as to draw fuel into the gap,
the armature including a hydraulic separation feature configured to improve hydraulic separation of the armature such that a travel time between the first and second (positions is reduced as the armature comes to rest, wherein the hydraulic separation feature includes at least one of a modified mass structure, a modified overtravel diameter structure, and one or more diffusion holes.

2. The armature of claim 1, wherein the armature is configured to define a travel time between the first and second positions, wherein the travel time includes the travel time between the first position and the second position.

3. The armature of claim 1, wherein the travel time between the first and second positions includes the travel time between the first position and the second position as well as the travel time over an overtravel distance.

4. The armature claim 1, wherein the hydraulic separation feature includes at least two of the modified mass structure, the modified overtravel diameter structure, and the one or more diffusion holes.

5. The armature of claim 1, wherein the hydraulic separation feature includes each of the modified mass structure, the modified overtravel diameter structure, and the one or more diffusion holes.

6. The armature of claim 1, wherein the hydraulic separation feature includes the modified mass structure and the modified overtravel diameter structure.

7. The armature of claim 1, wherein the hydraulic separation feature includes the modified mass structure and the one or more diffusion holes.

8. The armature of claim 1, wherein the modified overtravel diameter structure includes an overtravel diameter that is reduced along a length of the armature in a direction from the proximal end to the distal end.

9. The armature of claim 1, wherein the overtravel diameter structure is transitioned from a first diameter of a nominal diameter portion to the overtravel diameter via a chamfered transition portion between the nominal diameter and the overtravel diameter.

10. The armature of claim 1, and further comprising a fuel injector: including a body having a longitudinal axis extending between a proximal end and a distal end of the body; and a stator assembly configured to be received within the body.

11. The fuel injector of claim 8, wherein the hydraulic separation feature includes the one or more diffusion holes, and wherein the one or more diffusion holes is a plurality of diffusion holes through a flange of the armature, and wherein the plurality of diffusion holes is radially spaced about the longitudinal axis.

12. A method of operating an armature in a fuel injector, the method comprising:
moving the armature in a first direction as the armature moves from a first position to a second position to force fuel out of a gap, wherein a hydraulic separation feature alleviates a pressure of the fuel as the armature moves to the second position; and
moving the armature in a second direction as the armature moves from the second position to the first position to draw fuel into the gap, wherein the hydraulic separation feature enables the armature to alleviate pressures in the fuel injector caused by the movement of the armature.

13. The method of claim 12, further comprising positioning the armature adjacent the stator assembly in the fuel injector by the movement between first and second positions.

14. The method of claim 12, wherein moving the armature in a first direction comprises:
moving a bore of the armature along an axis of the fuel injector toward the second position;
forcing the fuel out of the gap using a flange of the armature; and
alleviating the pressure using at least one of:
a diffuser hole defined through the flange through which fuel flows;
an optimized mass structure configured to reduce pressure in the fuel; and
an optimized overtravel diameter structure configured to reduce pressure in the fuel.

15. The method of any one of claim 12, wherein moving the armature in a distal direction comprises:
moving a bore of the armature along an axis of the fuel injector toward the first position;
drawing the fuel into the gap using a flange of the armature; and alleviating pressure using at least one of:
a diffuser hole defined through the flange through which fuel flows;
a optimized mass structure configured to facilitate movement of the armature; and
an optimized overtravel diameter structure configured to facilitate movement of the armature.

16. A method of making an armature in a fuel injector for reduced travel time, the method comprising:
selecting the armature that is configured to travel between first and second positions relative to a stator included in the fuel injector; and
machining a hydraulic separation feature into a body of the armature, the hydraulic separation feature being configured to improve hydraulic separation of the armature such that a travel time between the first and second positions is reduced as the armature comes to rest, wherein the hydraulic separation feature includes at least one of a modified mass structure, a modified overtravel diameter structure, and one or more diffusion holes.

17. The method of claim 16, wherein machining the hydraulic separation feature into a body of the armature includes machining the hydraulic separation feature into the body of the armature such that the travel time between the first and second positions includes the travel time between the first position and the second position as well as the travel time over an overtravel distance.

18. The method as in claim 16, wherein machining the hydraulic separation feature into a body of the armature includes either machining the body of the armature to have the modified mass structure and the modified overtravel diameter structure or machining the body of the armature to have the modified mass structure and the one or more diffusion holes.

19. The method as in claim 16, wherein machining the hydraulic separation feature into a body of the armature includes machining the body of the armature to have the one or more diffusion holes, and wherein the one or more diffusion holes is a plurality of diffusion holes through a flange of the armature, and wherein the plurality of diffusion holes is radially spaced about a longitudinal axis of the fuel injector.

20. The method as in claim 16, wherein machining the hydraulic separation feature into a body of the armature includes causing the body to have the modified overtravel diameter, and wherein the modified overtravel diameter is reduced along a length of the armature in a direction from a proximal end of the armature to a distal end of the armature such that the overtravel diameter is transitioned from a nominal diameter to the overtravel diameter via a chamfered transition between the nominal diameter portion and the overtravel diameter portion (145) and the overtravel diameter is less than or equal to about 5 millimeters over the length of the armature.
